(19) United States
(12) Patent Application Publication
(10) Pub. No.: US 2015/0066291 A1
(43) Pub. Date: Mar. 5, 2015

(54) WEAR MONITORING SYSTEM FOR UNDERCARRIAGE COMPONENT

(71) Applicant: Caterpillar Inc., Peoria, IL (US)

(72) Inventors: Eric J. Johannsen, Washington, IL (US); Michael D. Hasselbusch, Metamora, IL (US); Roger L. Recker, Dunlap State/, IL (US)

(73) Assignee: Caterpillar Inc., Peoria, IL (US)

(21) Appl. No.: 14/538,810

(22) Filed: Nov. 12, 2014

(51) Int. Cl. B62D 55/08; G01N 3/56

(52) U.S. Cl. CPC B62D 55/08; G01N 3/56
USPC 701/34.4

(57) ABSTRACT

A wear monitoring system for an undercarriage component includes an ultrasonic sensor disposed on the undercarriage component. The ultrasonic sensor is configured to emit ultrasonic waves to detect wear of the undercarriage component. The wear monitoring system further includes a wear monitoring device disposed in communication with the ultrasonic sensor. The wear monitoring device is located remote to the ultrasonic sensor. Further, the wear monitoring device is configured to generate an output indicative of wear of the undercarriage component.

### TECHNICAL FIELD

The present disclosure relates to a wear monitoring system of an undercarriage component, and more particularly to a wear monitoring system using an ultrasonic sensor.

### BACKGROUND

Machines are used to perform various operations in different industries, such as construction, mining, transportation, and the like. Such machines may include an upper frame supported on an undercarriage. The undercarriage includes ground engaging members which provide propulsion to the machine. Operation of the machines may result in wear to various components of the undercarriage including the ground engaging members. For example, if the undercarriage includes a track assembly as a ground engaging member, each track link of the track assembly may undergo wear due to contact with other components of the track assembly and/or a ground surface.

Such components, which are prone to wear, may be periodically inspected to determine whether the components require repair or replacement. However, periodic inspections may result in machine downtimes. Further, timely identification of wear of the components may not be possible leading to further damage and/or potential failures of the components during operation of the machine.

US Patent Publication 2006/0243839 describes a method and apparatus for measuring and monitoring the setting of a crusher, in which method the erosion of the wearing parts of the crusher are monitored by sensors capable of transmitting the measurement data to the crusher's automatic control system. Based on the received measurement data, the control system adjusts the crusher setting so as to maintain the setting at its predetermined value irrespective of the erosion of the crusher's wearing parts. The invention also relates to alternative embodiments of wear sensors for the wearing parts of a crusher. The measurement data indicating the amount of erosion in the wearing parts is transmitted wirelessly to the exterior side of the crusher.

### SUMMARY OF THE DISCLOSURE

In one aspect of the present disclosure, a wear monitoring system for an undercarriage component is provided. The wear monitoring system includes an ultrasonic sensor disposed on the undercarriage component. The ultrasonic sensor is configured to emit ultrasonic waves to detect wear of the undercarriage component. The wear monitoring system further includes a wear monitoring device disposed in communication with the ultrasonic sensor. The wear monitoring device is located remote to the ultrasonic sensor. Further, the wear monitoring device is configured to generate an output indicative of wear of the undercarriage component.

Other features and aspects of this disclosure will be apparent from the following description and the accompanying drawings.

### BRIEF DESCRIPTION OF THE DRAWINGS

FIG. 1 illustrates an exemplary machine having an undercarriage;

FIG. 2 illustrates a wear monitoring system for a track link of the undercarriage, according to an embodiment of the present disclosure;

FIG. 3 illustrates a roller of the undercarriage provided with a wear sensor, according to an embodiment of the present disclosure;

FIG. 4 illustrates a track pin assembly of the undercarriage provided with a wear sensor, according to an embodiment of the present disclosure;

FIG. 5 illustrates a track shoe of the undercarriage provided with a wear sensor, according to an embodiment of the present disclosure; and

FIG. 6 illustrates an idler of the undercarriage provided with a wear sensor, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

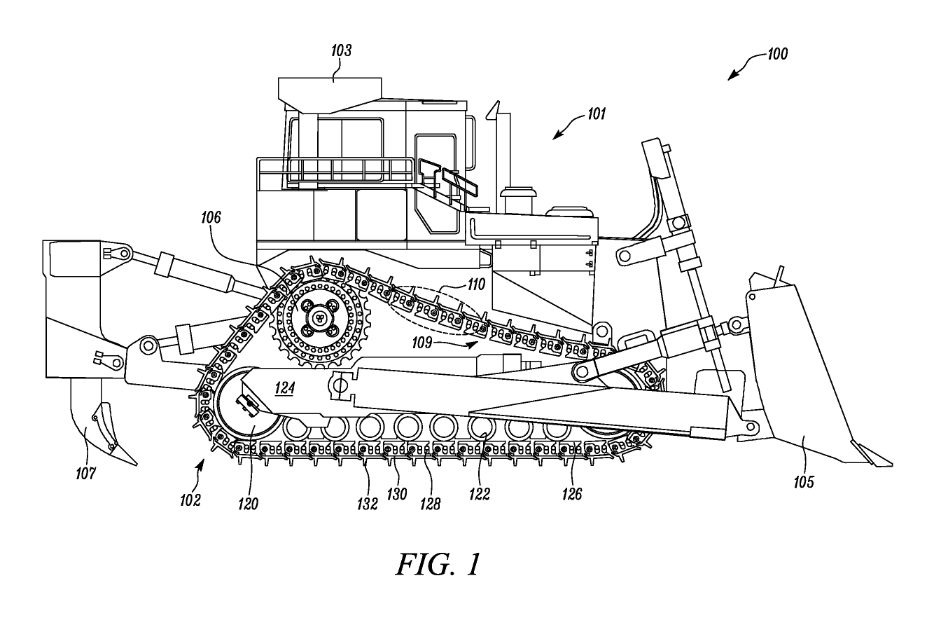

FIG. 1 illustrates an exemplary machine 100. The machine 100 includes an upper body 101 supported by an undercarriage 102. The upper body 101 may include an operator cabin 103. Further, a power source (not shown), such as an engine, may be disposed in the upper body 101. The power source may be configured to generate power to propel the machine 100, and operate a first implement 105 and a second implement 107 of the machine 100. In the illustrated embodiment, the machine 100 is a track-type tractor. Further, the first and second implements 105, 107 are a blade assembly and a ripper, respectively. However, the concepts of the present disclosure may be embodied in any type of machine having an undercarriage assembly 102, for example, skid steers, dozers, excavators, backhoes, track loaders, and the like.

The undercarriage 102 may include a pair of track assemblies 109 (only one shown) on opposing sides of the machine 100. The track assembly 109 may include a track 110, a drive sprocket 106, at least one idler 120, a plurality of rollers 122, and a frame assembly 124. The track 110 may form a continuous structure operatively coupled to the drive sprocket 106, the idlers 120, and the rollers 122. Further, the power source of the machine 100 may transmit power to the drive sprocket 106 via a driving mechanism. The driving mechanism may include a mechanical drive, a hydraulic drive, an electric drive, or a combination thereof.

The frame assembly 124 may carry the idlers 120. The frame assembly 124 may include multiple members (not shown) movable longitudinally relative to one another. During operation, a relative movement between the members of the frame assembly 124 may move the idlers 120 relative to one another. Further, rotation of the drive sprocket 106 may cause the drive the track 110 to move around the drive sprocket 106, the idlers 120, and the rollers 122 to engage a ground surface, and thereby propel the machine 100. The drive sprocket 106 may be driven in different directions to propel the machine 100 in forward or reverse directions. Further, the machine 100 may be steered by providing differential power to the drive sprockets 106 of the corresponding track assemblies 109.

In an exemplary embodiment, the track 110 may include a plurality of interconnected track links 126. Adjacent track links 126 may be rotatably coupled together via a track pin assembly 128. The track pin assembly 128 may be engaged by teeth of the drive sprocket 106 to drive the track 110 around the drive sprocket 106, the idlers 120, and the rollers 122.

The track 110 may further include a plurality of track shoes 130 secured to the track links 126. Each track shoe 130 may include a connecting portion configured to be secured to one or more of the track links 126 and a ground engaging portion 132 configured to contact the ground. The ground engaging portion 132 may include one or more portions (e.g., grouser bars) that provide increased traction between the track shoes 130 and the ground. It should be understood that the various components of the undercarriage 102, described above, are purely exemplary and not intended to be limiting of the present disclosure.

During operation, one or more undercarriage components, such as the rollers 122, the track shoes 130, the track links 126, and the track pin assemblies 128, and the like may undergo wear. These undercarriage components may require replacement and/or repair based on an extent of wear. The present disclosure relates to a wear monitoring system 200 configured to monitor an extent of wear of one or more undercarriage components, as will be explained hereinafter in detail.

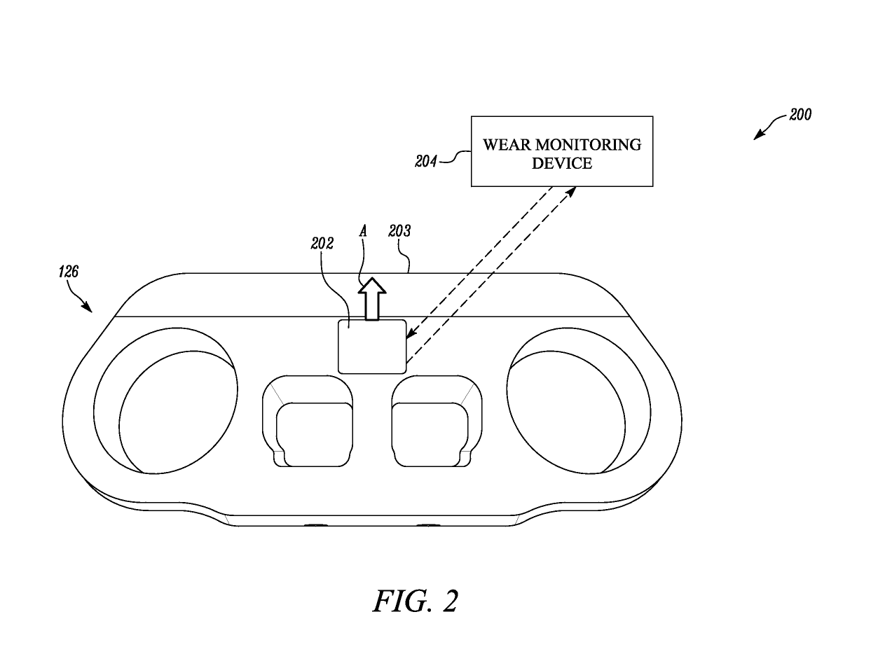

FIG. 2 illustrates the wear monitoring system 200 configured to monitor wear of an undercarriage component, according to an embodiment of the present disclosure. In the illustrated embodiment of FIG. 2, the undercarriage component is the track link 126. The wear monitoring system 200 includes at least one wear sensor 202 and at least one wear monitoring device 204. The wear monitoring device 204 is located remotely to the wear sensor 202. The wear monitoring device 204 and the wear sensor 202 are disposed in communication with each other. In an embodiment, the wear monitoring device 204 and the wear sensor 202 may wirelessly communicate with each other by various methods known in the art, for example, Bluetooth, Near field communication (NFC), infrared, radio waves, cellular networks like GSM, CDMA, WCDMA, HSPA, HSUPA, HSDPA, or any other known wireless communication methods. In another embodiment, the wear sensor 202 and the wear monitoring device 204 may be connected to each other by a cable, such as an electric cable, a fiber optic cable etc.

The wear monitoring device 204 may be positioned anywhere on the machine 100 that allows the wear monitoring device 204 to receive signals from the wear sensor 202. In an embodiment, the wear monitoring device 204 may be disposed in the upper body 101 of the machine 100. The wear monitoring device 204 may be installed in the operator cabin 103 of the machine 100. Alternatively, the wear monitoring device 204 may be mounted on an exterior surface of the machine 100. In yet another embodiment, the wear monitoring device 204 may be placed remotely from the machine 100.

The wear sensor 202 may be secured to the track link 126 by various methods. In one embodiment, the wear sensor 202 may be at least partially embedded within the track link 126. In another embodiment, the wear sensor 202 may be mounted on a surface of the track link 126. The wear sensor 202 may be configured to detect wear of the track link 126 and transmit a signal indicative of wear to the wear monitoring device 204. In an embodiment, the wear sensor 202 may be an ultrasonic sensor configured to emit ultrasonic waves, schematically shown as arrow ‘A’, in order to detect wear of the track link 126.

In an example, the wear sensor 202 may be configured to detect an extent of wear of the track link 126, and transmit signals when one or more wear thresholds are detected. Each of the wear thresholds may be indicative of a length of wear, area of wear, or a ratio of a detected dimension to an original dimension of the track link 126. The wear sensor 202 may be configured to monitor wear of a surface 203 of the track link 126. As shown in FIG. 2, the wear sensor 202 may be placed beneath the surface 203 on the track link 126. The surface 203 of the track link 126 may be disposed in contact with other undercarriage components, for example, the idler 120, the roller 122, the track shoe 130 etc., and may undergo wear out due to abrasion.

In operation, the wear sensor 202 may be configured to emit ultrasonic waves and receive reflected ultrasonic waves from the surface 203. The wear sensor 202 may be further configured determine an elapsed time span between transmission and receipt of the ultrasonic waves. The elapsed time span may vary with progressive wear of the track link 126. For example, elapsed time span for an unworn undercarriage component may be different to elapsed time for a worn undercarriage component due to change in dimensions of the undercarriage component. The variation in elapsed time span may be correlated to the wear thresholds described above. When a specific wear threshold is reached, the wear sensor 202 may transmit a signal indicative of the extent of wear of the track link 126 to the wear monitoring device 204. The wear monitoring device 204 may generate an output indicative of wear of the track link 126. The output may include an alert, for example, an audio, visual or a tactile alert. Further, the output may include a signal to a central server accessible by service personnel, manufacturer or a dealer. Additionally, the wear monitoring device 204 may also store data related to wear of the track link 126 in a memory. The wear monitoring device 204 may include one or more ports which enable an external device to be connected thereto in order to access stored data related to wear.

The wear monitoring device 204 may also be configured to transmit information received from the wear sensor 202 to on-board or off-board devices (not shown). For example, the monitoring device 204 may be in communication with a machine controller (not shown). Moreover, the monitoring device 204 may be in communication with smartphones, laptops, or any portable device known in the art.

Although, the wear monitoring system 200 including the wear sensor 202 and the wear monitoring device 204 has been described for wear monitoring of the track link 126, it should be understood that the wear monitoring system 200 can be employed for wear monitoring of any undercarriage component. Various examples of such undercarriage components are described hereinafter in detail.

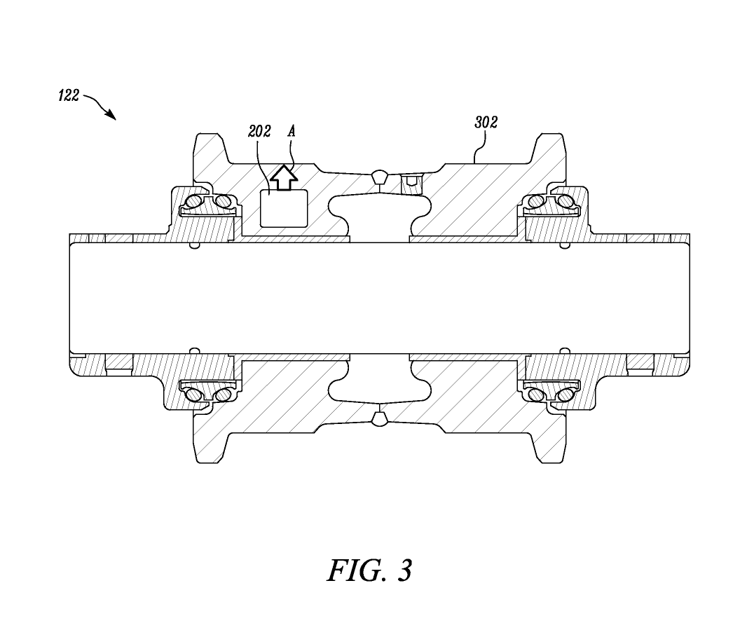

FIG. 3 illustrates the wear sensor 202 installed on the roller 122, according to an embodiment of the present disclosure. In the illustrated embodiment, the wear sensor 202 is configured to detect wear of the roller 122. The wear sensor 202 may be in communication with the wear monitoring device 204 (shown in FIG. 2). The wear sensor 202 may be disposed proximate a tread surface 302 of the roller 122. The roller 122 may support and guide the track links 126 of the track assembly 109 as the machine 100 travels along the ground. In operation, the tread surface 302 of the roller 122 may be in contact with the track links 126, resulting in wear of the tread surface 302. The wear monitoring system 200 may monitor wear of the tread surface 302 in a similar manner as explained above in conjunction with FIG. 2.

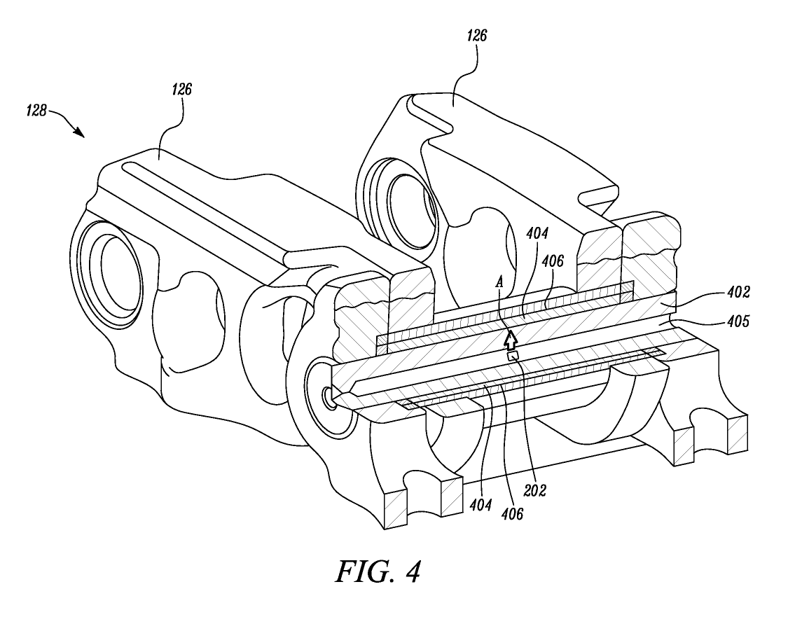

FIG. 4 illustrates the wear sensor 202 installed on the track pin assembly 128, according to an embodiment of the present disclosure. In the illustrated embodiment, the wear sensor 202 may be configured to detect wear of the track pin assembly 128. The wear sensor 202 may be in communication with the wear monitoring device 204 (shown in FIG. 2). The track pin assembly 128 may include a pin 402 and a bushing 404. The track pin assembly 128 may pivotally coupled adjacent track links 126. Various surfaces if the pin 402 and/or the bushing 404 may undergo wear during operation. The wear sensor 202 may be disposed within a center hole 405 of the pin 402. The wear sensor 202 may be embedded within a wall of the central hole 405. Alternatively, the wear sensor 202 may be mounted externally on the wall of the central hole 405. It may also be contemplated that the wear sensor 202 may be placed on any location on the track assembly 109. In an example, the wear sensor 202 may be configured to detect wear of a surface 406 of the bushing 404. The wear monitoring system 200 may monitor wear of the surface 406 in a similar manner as explained above in conjunction with FIG. 2.

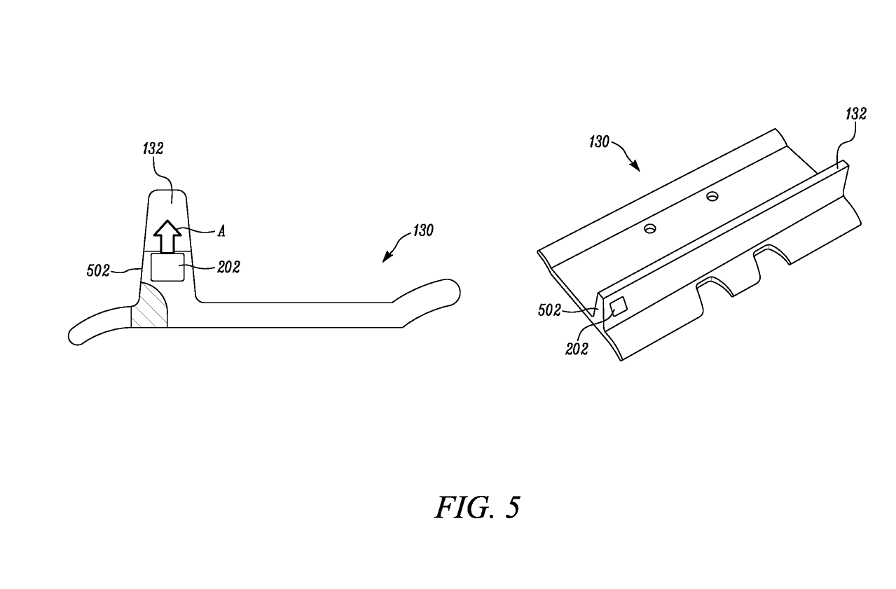

FIG. 5 illustrates the wear sensor 202 installed on the track shoe 130, according to an embodiment of the present disclosure. In the illustrated embodiment, the wear sensor 202 may be configured to detect wear of the track shoe 130. The wear sensor 202 may be in communication with the wear monitoring device 204 (shown in FIG. 2). The track shoe 130 may include the ground engaging portion 132 that contacts the ground during travel of the machine 100. The ground engaging portion 132 may be the grouser bar associated of the track shoe 130. A surface 502 of the ground engaging portion 132 may be prone to wear. The wear sensor 202 may be disposed proximate the surface 502 of the ground engaging portion 132. The wear sensor 202 may be embedded in the ground engaging portion 132. Alternatively, the wear sensor 202 may be externally mounted on the ground engaging portion 132. The wear monitoring system 200 may monitor wear of the ground engaging portion 132 in a similar manner as explained above in conjunction with FIG. 2.

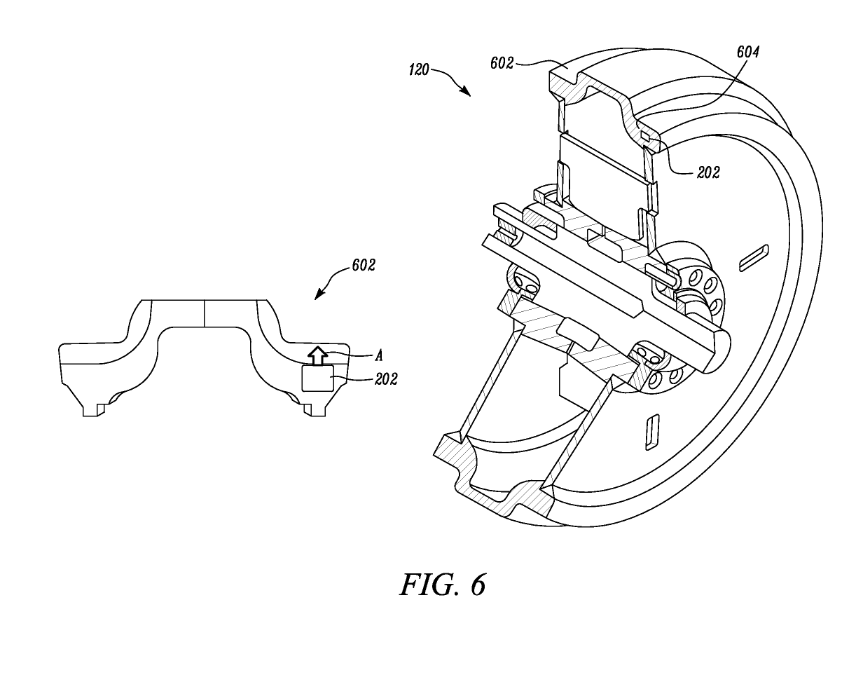

FIG. 6 illustrates the wear sensor 202 installed on the idler 120, according to an embodiment of the present disclosure. In the illustrated embodiment, the wear sensor 202 may be configured to detect wear of the idler 120. The wear sensor 202 may be in communication with the wear monitoring device 204 (shown in FIG. 2). The wear sensor 202 may be disposed on a tread shoulder 602 of the idler 120. A surface 604 of the tread shoulder 602 may be in contact with the track links 126, leading to wear of the surface 604. The wear monitoring system 200 may monitor wear of the surface 604 in a similar manner as explained above in conjunction with FIG. 2.

It may be contemplated that the wear monitoring system 200 may include multiple wear sensors 202 disposed on corresponding undercarriage components. In an embodiment, the multiple wear sensors 202 may be in communication with a single monitoring device 204. Alternatively, a separate monitoring device 204 may be provided for each wear sensor 202.

### INDUSTRIAL APPLICABILITY

The present disclosure is related to the wear monitoring system 200 for an undercarriage 102 component of the machine 100. The monitoring system 200 may include the wear sensor 202 for detecting wear of the undercarriage component. Further, the wear sensor 202 may be in communication with the monitoring device 204. The monitoring device 204 may be configured to generate an output indicative of wear of the undercarriage component. As explained above, the undercarriage component may include, for example, but not limited to, the track link 126, the idler 120, the roller 122, the track shoe 130 etc.

The wear monitoring system 200 may enable real time monitoring of wear of the undercarriage component. Further, the wear sensor 202 may be an ultrasonic sensor disposed on the undercarriage component, thereby enabling accurate determination of an extent of wear. Extent of wear may indicate whether the undercarriage component requires repair and/or replacement. Further, the wear monitoring system 200 may provide an alert if the undercarriage component requires immediate attention, thereby preventing any possible failures of the undercarriage component. Hence, machine downtimes may be reduced.

The wear monitoring system 200 may also be configured to store wear data. Wear data may be accessible in order to optimize maintenance and operation schedules of the machine 100, determine working life of various undercarriage components etc. Further, manual inspection of the undercarriage components may be reduced.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A wear monitoring system for an undercarriage component, the wear monitoring system comprising:
an ultrasonic sensor disposed on the undercarriage component, the ultrasonic sensor configured to emit ultrasonic waves to detect wear of the undercarriage component; and
a wear monitoring device disposed in communication with the ultrasonic sensor, wherein the wear monitoring device is located remote to the ultrasonic sensor, and wherein the wear monitoring device is configured to generate an output indicative of wear of the undercarriage component.
